(19) United States
(12) Patent Application Publication
(10) Pub. No.: US 2006/0000871 A1
(43) Pub. Date: Jan. 5, 2006

(54) System and method for management of surface mount technology stencils

(75) Inventors: Chi-Chih Wang, Tu-Cheng (TW); Bing-Yu He, Shenzhen (CN); Chang-Gen Fang, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/168,218

(22) Filed: Jun. 28, 2005

(30) Foreign Application Priority Data
Jul. 2, 2004 (CN) 200410027977.9

(51) Int. Cl. B23K 35/12; B23K 13/08

(52) U.S. Cl. 228/8; 228/39; 228/102

(57) ABSTRACT

A system for management of SMT stencils includes: a plurality of controllers (5), each of which is connected to a sensor (7) for generating a signal when a piece of PCB is passing through an SMT machine (4) on which an SMT stencil is mounted and for adding one to each of current cumulative operation times and current continuous operation times of the stencil; and a server (1) including: a data obtaining module (12) for obtaining signals from the controllers; a parameter setting module (13) for presetting parameters of each stencil; an analyzing module (14) for obtaining the current cumulative operation times and current continuous operation times of the stencil; and a determining module (15) for determining a usage condition of the stencil by comparing the current cumulative operation times and current continuous operation times with respective preset parameters, and generating different messages according to different usage conditions of the stencil. A related method is also disclosed.

### BACKGROUND OF THE INVENTION

1. Field of the Invention

This invention is related to systems and methods for management of tools, and especially to a system and method for management of surface mount technology stencils.

2. General Background

Surface mount technology (SMT) is a basic technology for producing printed circuit boards (PCBs) in the area of manufacturing of personal computers, communications and consumer electronics (3C). SMT stencils are key fittings utilized in SMT, which are essentially printing molds made by metal or by polymer. When a PCB is passing through an SMT machine, an SMT stencil which is mounted on the SMT machine covers the PCB. Then, the SMT machine prints liquid tin on the surface of the PCB. Therefore, a tin-covered rough circuit of the PCB will be formed according to the shape of holes on the SMT stencil. However, the tin remained on the surface of the SMT stencil is harmful to the quality of the PCBs produced subsequently. When the SMT stencil has been used for a certain period, the tin on the surface of the SMT stencil should be cleaned. After the stencil has been cleaned for certain times, it must be discarded in case that any quality problem occurs. Therefore, maintenance of the SMT stencil is very important.

Accordingly, what is needed is a system for management of SMT stencils, which can easily determine a usage condition of an SMT stencil in order to better maintain the SMT stencil.

What is also needed is a method for management of SMT stencils, which can easily determine a usage condition of an SMT stencil in order to better maintain the SMT stencil.

### SUMMARY OF THE INVENTION

A preferred embodiment of the present invention provides a system for management of SMT stencils. The system includes a plurality of controllers and a server connected to the controllers. Each of the controllers is connected to a sensor, for generating a signal when a piece of PCB is passing through an SMT machine on which an SMT stencil is mounted, and for adding one to each of current cumulative operation times and current continuous operation times of the stencil. The server includes: a data obtaining module for obtaining the signals from the controllers and transforming the signals into readable data; a parameter setting module for presetting parameters of each stencil, which typically include maximal operation times and maximal continuous operation times; an analyzing module for obtaining the current cumulative operation times and current continuous operation times of the stencil; and a determining module for determining a usage condition of the stencil by comparing the current cumulative operation times and current continuous operation times with respective preset parameters, and for generating different messages according to different usage conditions of the stencil.

Another preferred embodiment of the present invention provides a method for management of a SMT stencil. The method includes the steps of: setting parameters of the stencil, the parameters including maximal operation times and maximal continuous operation times; sensing a piece of PCB passing through an SMT machine on which the stencil is mounted; obtain current cumulative operation times and current continuous operation times of the stencil; determining whether the current cumulative operation times exceed the maximal operation times of the stencil; generating a command of replacing the stencil if the current cumulative operation times exceed the maximal operation times of the stencil; determining whether the current continuous operation times exceed the maximal continuous operation times, if the current cumulative operation times do not exceed the maximal operation times of the stencil; and generating a command of cleaning the stencil if the current continuous operation times exceed the maximal continuous operation times.

Other advantages and novel features of the present invention will be drawn from the following detailed description of a preferred embodiment and preferred method thereof together with the attached drawings, in which:

### BRIEF DESCRIPTION OF THE DRAWINGS

FIG. 1 is a schematic diagram of hardware configuration of a system for management of SMT stencils in accordance with a preferred embodiment of the present invention;

FIG. 2 is a schematic diagram of main function modules of the server of FIG. 1; and

FIG. 3 is a flow chart of a preferred method for management of an SMT stencil by utilizing the system of FIG. 1.

### DETAILED DESCRIPTION OF THE PREFERRED EMBODIMENT

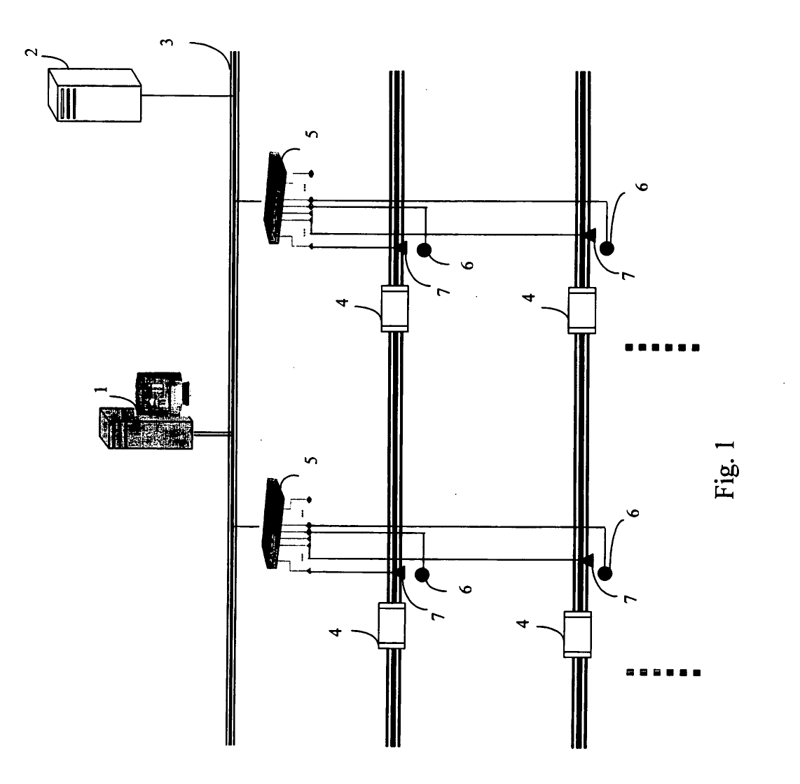

FIG. 1 is a schematic diagram of hardware configuration of a system for management of tools like SMT stencils in accordance with a preferred embodiment of the present invention. A server 1 is connected with a database 2 and plurality of controllers 5 (only two shown) through a network 3. Each controller 5 is connected with a plurality of sensors 7 (only two shown) and alarms 6 (only two shown). Each sensor 7 and a corresponding alarm 6 are connected to an SMT machine 4, on which an SMT stencil is mounted, for printing liquid tin on PCBs passing thereunder.

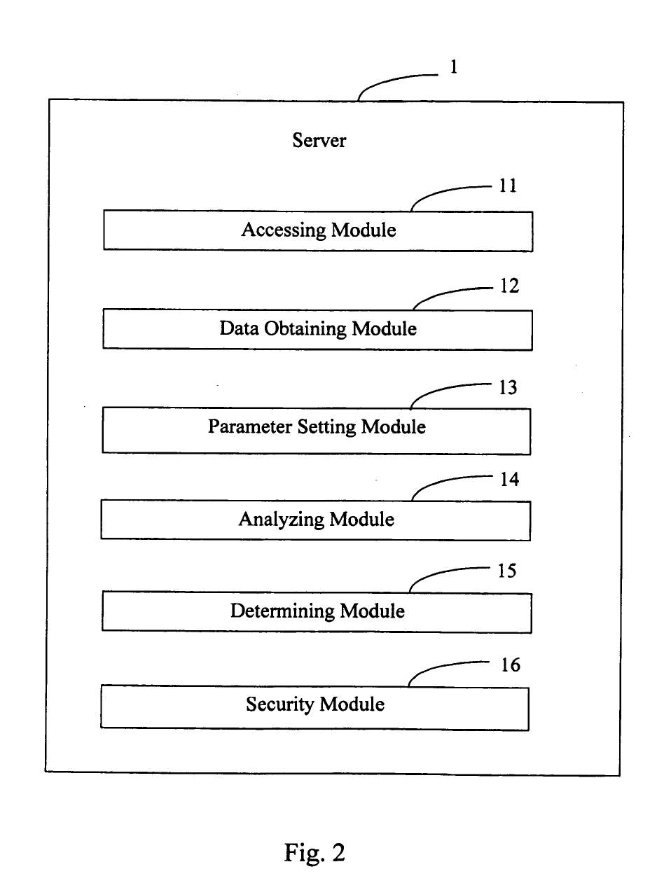

The server 1 is typically a server computer, and includes several function modules (described in detail in relation to FIG. 2), for controlling the controllers 5 and accessing data from the database 2.

The database 2 may be an SQL server 2000 database, or any other database known in the art. Data stored in the database 2 includes signals sent from the controllers 5, and parameters of each stencil. The parameters generally includes predetermined maximal operation times and maximal continuous operation times of the stencil, and other information on the stencil such as a manufacturer name, a supplier name, an identification number, a production date, types of PCBs that can be produced by the stencil, a thickness and a mounting position of the stencil, and current cumulative operation times and current continuous operation times of the stencil. The information on the stencil can be added or deleted according to particular requirements during the process of manufacturing.

Each sensor 7 has a counter installed therein, and can be a photoelectric switch for counting current cumulative operation times and current continuous operation times of a corresponding stencil. When a PCB pass through an SMT machine 4 to which the sensor 7 is connected, the sensor 7 generates a signal sent to a corresponding controller 5, and adds one to each of the current cumulative operation times and the current continuous operation times of the stencil. Each alarm 6 is a security device for alarming, and can be a bell alarm, or light alarm, or any other suitable kind of alarm.

The controller 5 is used for obtaining signals from the sensor 7 and for controlling the alarm 6. The controller 5 is also used for controlling the operation of the SMT machine 4 according to a usage condition of the stencil, which is determined by the server 1. For example, if current cumulative operation times of the stencil exceed its predetermined maximal operation times, the controller 5 shuts down the SMT machine 4, in order that the stencil can be replaced by a new one. Or, if current continuous operation times of the stencil exceed predetermined continuous operation times, the controller 5 shuts down the SMT machine 4 for an operator to clean the stencil.

FIG. 2 is a schematic diagram of main function modules of the server 1. The server comprises: an accessing module 11, a data obtaining module 12, a parameter setting module 13, an analyzing module 14, a determining module 15, and a security module 16.

The accessing module 11 is for accessing data in the database 2. The data obtaining module 12 is for obtaining signals from the controllers 5, and for transforming the signals into readable data. The signals are generated by the sensors 7 when PCBs are passing through the SMT machines 4, and are transited to the server 1 through the controllers 5. The data obtaining module 12 may comprise a plurality of hardware and software configurations, for example, a data collecting card and kit software.

The parameter setting module 13 is for setting parameters of each stencil, and for storing the parameters in the database 2. The parameters typically include maximal operation times and maximal continuous operation times, and are set before the stencil is mounted on an SMT machine 4. However, the parameters can also be updated any time during the process of manufacturing.

The analyzing module 14 is for analyzing the data in the database 2. The analyzing module 14 can also obtain current cumulative operation times and current continuous operation times of a stencil from a sensor 7, and update the parameters of the stencil stored in the database 2.

The determining module 15 is for determining a usage condition of each stencil, by comparing current cumulative operation times with corresponding maximal operation times of the stencil. If the current cumulative operation times exceed the maximal operation times, the determining module 15 sends a first message to the security module 16. If the current cumulative operation times do not exceed the maximal operation times, the determining module 15 further compares the current continuous operation times with corresponding maximal continuous operation times. If the current continuous operation times exceed the maximal continuous operation times, the determining module 15 sends a second message to the security module 16.

The security module 16 is for generating a command of replacing the stencil according to the first message, and generating a command of cleaning the stencil according to the second message. The commands are sent to the controllers 5 for controlling of the alarms 6 and the SMT machines 4.

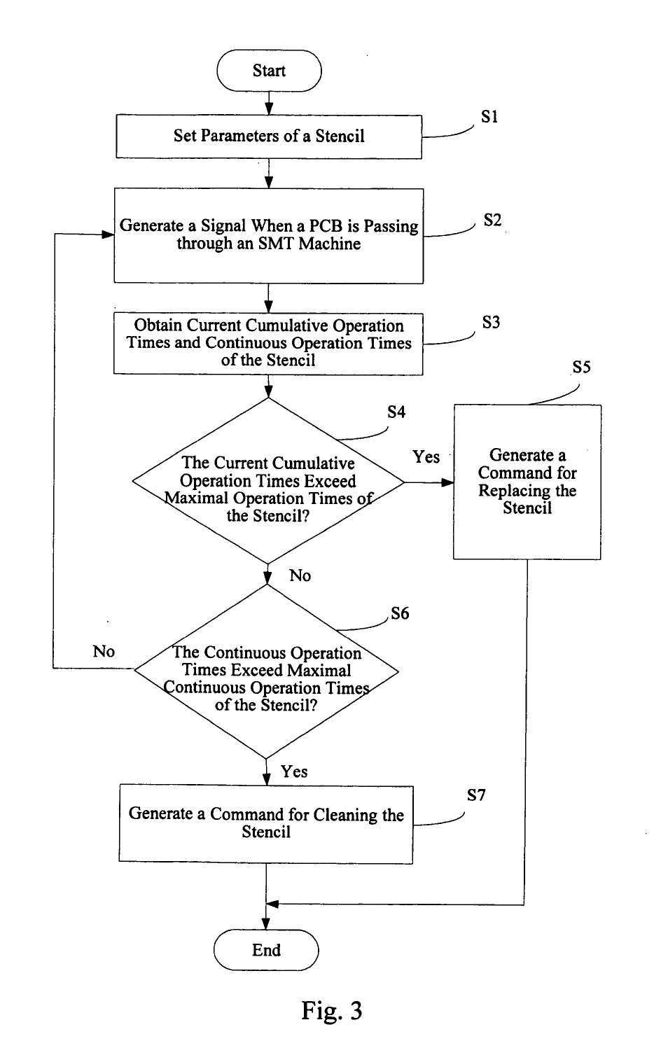

FIG. 3 is a flow chart of a preferred method for management of an SMT stencil by utilizing the system of FIG. 1. In step S1, the parameter setting module 13 sets relevant parameters of the stencil, and stores the parameters in the database 2. In step S2, the corresponding sensor 7 senses one piece of PCB passing through an SMT machine 4 on which the stencil is mounted, generate a signal, and transmits the signal to the server 1 through a corresponding controller 5. The sensor 7 also adds one to each of the current cumulative operation times and the current continuous operation times of the stencil. In step S3, the analyzing module 14 obtains the current cumulative operation times and the current continuous operation times of the stencil. In step S4, the determining module 15 compares the current cumulative operation times with predetermined maximal operation times of the stencil. If the current cumulative operation times exceed the maximal operation times of the stencil, in step S5, the determining module 15 generates a command for replacing the stencil, and sends the command to the controller 5. The alarm 6 then alarms to remind an operator of replacing the stencil, whereupon the procedure is finished. In contrast, if the current cumulative operation times do not exceed the maximal operation times of the stencil, in step S6, the determining module 15 compares the current continuous operation times with predetermined maximal continuous operation times of the stencil. If the current continuous operation times do not exceed the maximal continuous operation times of the stencil, the procedure goes to step S2 described above. In contrast, if the current continuous operation times exceed the maximal continuous operation times of the stencil, in step S7, the determining module 15 generates a command for cleaning the stencil, and sends the command to the controller 5. The alarm 6 then alarms to remind the operator of cleaning the stencil. Then, the current continuous operation times are reset to zero, and the procedure is finished.

Although the present invention has been specifically described on the basis of a preferred embodiment and preferred method, the invention is not to be construed as being limited thereto. Various changes or modifications may be made to the embodiment and method without departing from the scope and spirit of the invention.

We claim:

1. A system for management of surface mount technology (SMT) stencils, the system comprising:
a plurality of controllers, each controller being connected to a sensor, the sensor being for generating a signal when a piece of printed circuit board (PCB) is passing through an SMT machine on which an SMT stencil is mounted and for adding one to each of current cumulative operation times and current continuous operation times of the stencil;
a server connected with the controllers, the server comprising:
a data obtaining module for obtaining the signals from the controllers and transforming the signals into readable data;
a parameter setting module for presetting parameters of each stencil, the parameters comprising maximal operation times and maximal continuous operation times;
an analyzing module for obtaining the current cumulative operation times and current continuous operation times of the stencil; and
a determining module for determining a usage condition of the stencil by comparing the current cumulative operation times and current continuous operation times with respective preset parameters, and generating different messages according to different usage conditions of the stencil.

2. The system according to claim 1, further comprising a database for storing data.

3. The system according to claim 2, wherein the server further comprises an accessing module for accessing data in the database.

4. The system according to claim 1, wherein the server further comprises a security module for generating different commands according to the different messages.

5. The system according to claim 4, wherein each of the controllers is further connected to an alarm for alarming according to the commands.

6. The system according to claim 5, wherein the commands comprise a command for replacing the stencil.

7. The system according to claim 5, wherein the commands comprise a command for cleaning the stencil.

8. The system according to claim 1, wherein the sensor is a photoelectric switch which has a counter installed therein.

9. A computer-based method for management of a surface mount technology (SMT) stencil, the method comprising the steps of:
setting parameters of the stencil, the parameters comprising maximal operation times and maximal continuous operation times;
sensing a piece of printed circuit board (PCB) passing through an SMT machine on which the stencil is mounted;
obtain current cumulative operation times and current continuous operation times of the stencil;
determining whether the current cumulative operation times exceed the maximal operation times of the stencil;
generating a command of replacing the stencil if the current cumulative operation times exceed the maximal operation times of the stencil;
determining whether the current continuous operation times exceed the maximal continuous operation times, if the current cumulative operation times do not exceed the maximal operation times of the stencil; and
generating a command of cleaning the stencil if the current continuous operation times exceed the maximal continuous operation times.

10. The method according to claim 9, further comprising the step of: returning to the sensing step if the current continuous operation times do not exceed the maximal continuous operation times.

11. A method for management of manufacturing tools, the method comprising the steps of:
predetermining at least two life-related parameters of said tools;
counting a first number of current cumulative operation times and a second number of current continuous operation times respectively for usage of said tools during a manufacturing process adopting said tools;
comparing said first and second numbers with corresponding ones of said at least two life-related parameters so as to generate at least two responsive messages according to comparative results thereof; and
responding a request of a first action for said tools to a first one of said at least two responsive messages, and another request of a second action for said tools, different from said first action, to a second one of said at least two responsive messages.

12. The method according to claim 11, wherein said tools include a surface mount technology (SMT) stencil.

13. The method according to claim 12, wherein said first one of said at least two responsive messages is responsive to one of said comparative results of said first number and corresponding parameters thereof so as to request said first action to replace said stencil.

14. The method according to claim 12, wherein said second one of said at least two responsive messages is responsive to one of said comparative results of said second number and corresponding parameters thereof so as to request said second action to clean said stencil.
